(19) United States
(12) Patent Application Publication
(10) Pub. No.: US 2026/0187081 A1
(43) Pub. Date: Jul. 2, 2026

(54) SYSTEM AND COMPUTER-IMPLEMENTED METHOD FOR SEARCHING AND RANKING VECTOR REPRESENTATIONS OF DATA RECORDS

(71) Applicant: WESCO Distribution, Inc., Pittsburgh, PA (US)

(72) Inventors: Avinash WESLEY, New Caney, TX (US); Rafael DA MATTA NAVARRO, Houston, TX (US); Shashi DANDE, Spring, TX (US); Raja Vikram Raj PANDYA, Katy, TX (US); Kishor SAITWAL, Sugar Land, TX (US); Merwan MEREBY, Baton Rouge, LA (US); Akash KHURANA, Houston, TX (US); Ashok BAJAJ, Katy, TX (US)

(73) Assignee: WESCO Distribution, Inc., Pittsburgh, PA (US)

(21) Appl. No.: 19/129,985

(22) PCT Filed: Nov. 13, 2023
(86) PCT No.: PCT/US2023/037177

§ 371 Date: May 14, 2025

Related U.S. Application Data
(60) Provisional application No. 63/425,151, filed on Nov. 14, 2022.

(51) Int. Cl. G06F 16/2457; G06F 16/22

(52) U.S. Cl. CPC G06F 16/24578; G06F 16/2264

(57) ABSTRACT

Systems, computer-implemented methods, and computer-readable storage media for allowing users to search database(s) for records similar to a queried record. Based on the queried record, the system can generate a multidimensional query vector based on the query record, wherein each dimension of the multidimensional query vector is associated with at least one attribute within the plurality of attributes, the database comprising additional multidimensional vectors which are not retrieved. The system can then rank the multidimensional vectors according to a similarity to the multidimensional query vector, and select a top K highest ranked multidimensional vectors. The system can identify at least one result record corresponding to the top K highest ranked multidimensional vectors and provide to the user in response to the query with the at least one result record.

### PRIORITY

This application claims priority to U.S. Provisional Patent Application No. 63/425,151, filed Nov. 14, 2022, the contents of which are incorporated herein in their entirety.

### BACKGROUND

### 1. Technical Field

The present disclosure relates to searching and ranking vector representations of data records, and more specifically to optimized searching of a database using vector representations.

### 2. Introduction

Searching large databases of records is a computationally expensive process.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, computer-implemented methods, and non-transitory computer-readable storage media which provide a technical solution to the technical problem described. A computer-implemented method for performing the concepts disclosed herein can include: receiving, at a computer system, a query from a user, the query comprising: a query record, the query record comprising a plurality of attributes; and a request for at least one record similar to the query record; generating, via at least one processor of the computer system, a multidimensional query vector based on the query record, wherein each dimension of the multidimensional query vector is associated with at least one attribute within the plurality of attributes; retrieving, via the at least one processor from a database of the computer system, a plurality of known multidimensional vectors, the database comprising additional multidimensional vectors which are not retrieved; ranking, via the at least one processor, the plurality of known multidimensional vectors according to a similarity to the multidimensional query vector, resulting in a ranked list of candidate multidimensional vectors; selecting, via the at least one processor, top K highest ranked multidimensional vectors from the ranked list of candidate multidimensional vectors, K being a predetermined number; identifying, via the at least one processor, at least one result record corresponding to the top K highest ranked multidimensional vectors; and responding, via the at least one processor, to the user in response to the query with the at least one result record.

A system configured to perform the concepts disclosed herein can include: a processor; and a computer-readable storage medium storing instructions which, when executed by the processor, cause the processor to perform operations comprising: receiving, at a computer system, a query from a user, the query comprising: a query record, the query record comprising a plurality of attributes; and a request for at least one record similar to the query record; generating a multidimensional query vector based on the query record, wherein each dimension of the multidimensional query vector is associated with at least one attribute within the plurality of attributes; retrieving, from a database of the computer system, a plurality of known multidimensional vectors, the database comprising additional multidimensional vectors which are not retrieved; ranking the plurality of known multidimensional vectors according to a similarity to the multidimensional query vector, resulting in a ranked list of candidate multidimensional vectors; selecting top K highest ranked multidimensional vectors from the ranked list of candidate multidimensional vectors, K being a predetermined number; identifying at least one result record corresponding to the top K highest ranked multidimensional vectors; and responding to the user in response to the query with the at least one result record.

A non-transitory computer-readable storage medium configured as disclosed herein can have instructions stored which, when executed by a computing device, cause the computing device to perform operations which include: receiving, at a computer system, a query from a user, the query comprising: a query record, the query record comprising a plurality of attributes; and a request for at least one record similar to the query record; generating a multidimensional query vector based on the query record, wherein each dimension of the multidimensional query vector is associated with at least one attribute within the plurality of attributes; retrieving, from a database of the computer system, a plurality of known multidimensional vectors, the database comprising additional multidimensional vectors which are not retrieved; ranking the plurality of known multidimensional vectors according to a similarity to the multidimensional query vector, resulting in a ranked list of candidate multidimensional vectors; selecting top K highest ranked multidimensional vectors from the ranked list of candidate multidimensional vectors, K being a predetermined number; identifying at least one result record corresponding to the top K highest ranked multidimensional vectors; and responding to the user in response to the query with the at least one result record.

### BRIEF DESCRIPTION OF THE DRAWINGS

FIG. 1 illustrates an example of a hierarchical record;

FIG. 2 illustrates an example of a multidimensional space for a record vector representation;

FIG. 3 illustrates an exemplary record search cycle;

FIG. 4A illustrates an example chart of vector representations of records being graphed according to normalized similarity scores and ratings;

FIG. 4B illustrates an example of using linear regression to identify a top ranking similarity score among the vector representations;

FIG. 5 illustrates an example system receiving a query;

FIG. 6 illustrates an example computer-implemented method embodiment; and

FIG. 7 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Businesses and organizations are required (both legally and organizationally) to store vast amounts of information about the products and services rendered. This information can then be used to identify nearly all aspects of how the products/services were produced, delivered, received, etc., and under what terms/rules (contractual or otherwise) the products/rules were rendered. For example, a distribution company may retain records about how and when a product was manufactured, from which entity it was received, and may retain additional information identifying the receiving entity to which the product was delivered and under what contract, terms, or other rules that delivery took place.

Systems configured as disclosed herein allow users to search database(s) for records similar to a queried record in a manner which is more computationally efficient than searching all stored records. For example, consider a manufacturer that produces various items in batches, such that when a new item is produced which is similar to previously made items a significant amount of time has passed since those previously made items were made. In such a situation, when new products are made the manufacturer may want to create new records for those newly manufactured products, where the new records are generally similar to the records for the previous batch but may vary in specific ways. Systems configured as disclosed herein allow the manufacturer to efficiently search the database of previous records for similar records, rank those similar records based on similarity, and present the top results to the manufacturer.

Consider another example. A distributor is seeking to transport goods from location A to location B, and would like to know what the previous, similar contracts (including shipping and cost rebate contracts) were with shippers so that the distributor has a starting point in negotiations with the shippers for a new transport/delivery. In such a scenario, multiple factors could be considered “similar,” such as: the same goods being shipped, shipping from location A (not necessarily to location B), shipping to location B (not necessarily from location A), shipping from locations A to B, similar dates (e.g., days of the week, holidays, seasons), shipping companies used, etc. In such a scenario, the system disclosed herein can identify many previous records of shipping contracts (such as shipping and cost rebate contracts) based on any of those conditions, rank them based on similarity to the new circumstances, and then perform a re-ranking based on a linear regression (or other best-fit test) to determine which of the previous contracts would be the best starting point for the distributor's negotiations.

To make recommendations, the system can use one or more parts of a multi-step recommendation model. The recommendation model is a data-driven model that can first identify similarity scores between different dimensions within a multi-dimensional vector representation of a data record. For example, the system can calculate a cosine similarity score (or other similarity score calculation) between different dimensions within a vectors representation of the record. The resulting similarity score can then be normalized and used to create a grid (which can be visualized, in some configurations, as a two dimensional chart) using the normalized similarity score and a rating of each respective record. Whereas the normalized similarity score is based on how similar one record is to another, the rating is based on a particular domain or a user selected aspect of optimization/emphasis. For example, for ship and debit rebates, the rating can be based on the lowest cost possible. The lower the cost of an item the higher the rating for that item in the recommended list. A linear regression, PCA (Principal Component Analysis), or other analysis to model the relationship between the normalized similarity score and the rating, allowing the system to rank the identified records according to a “best fit.” The resulting ranked records can then be presented to the user.

### Records

Records refer to information stored within a computer system, where the information stored by a user, company, or other entity is related to a product, service, transaction, sales location, or other event. A record encapsulates details which can be used by users in determining how new records should be completed.

A non-limiting exemplary record can have the following properties:
Geography
   Region
   District
   Branch
   Customer data
   Customer identification number with the distribution company
   Customer's industry segment
   Customer's industry sub-segment
   Universal numbering system and creditworthiness (e.g., DUNS (Data Universal Numbering System) number)
      Global DUNS
      Divisional DUNS
   Global account information
Product catalog
   Product classification
   Product sub-classification
   Price group code
   Product manufacturer number
   Product item number
      Record Vector Embedding-Converting Categorical Nominal Data into a Vector Representation

Records have categorical data and can be translated into a lower-dimensional space. For example, geographic regions can be numbered, such that the name of the geographic region stored in the record (e.g., “Dallas”) can be converted into a number (i.e., the lower-dimensional space). This process is called embedding. Embedding can capture most of the semantics of the data within the record and place semantically similar inputs, or inputs which are otherwise close to one another (e.g., geographically, numerically, or on a scale defined by a user) closer within the embedding space (for example, the numbers for the vector representation of “Fort Worth” and “Dallas” will be closer in value than the numbers for “Dallas” and “New York”, assuming those are geographical representations). The embedding process can compromise AI (Artificial Intelligence), machine learning, neural networks, and/or any other embedding algorithms known to those of skill in the art which can convert categorical data into a lower-dimensional vector.

### Search Space Compression-Removing Irrelevant Embedded Vectors

The embedded vector space can be a specialized vector space containing a large number of vectors that need to be further reduced. The system can filter out the embedded vectors based one or more vector types. For example, the system can perform a compressed-domain search of records (in the form of vector representations) for products based on the manufacturer number (or other filter category) saved within the records. Based on a user-specified filter, the system can then remove any records which do not have (or which have) the specified filter. As another example, the query may provide a query record and can use the system to search for records similar to the query record. The user can, for example enter the query record using a computer system by filling in (e.g., using an input device) values for specific attributes (i.e., fields) to be searched for, where the combination of those specific attributes is the query record. The query record can be converted into a multi-dimensional query vector, such that and the system can identify records which are similar to the query record based on comparisons to the multi-dimensional query vector. For example, based on the query record, only the embedded vectors representations that have one or more user-selected category (such as common manufacturer, common origin, common destination, etc.) will be kept as possible matches while the rest of the embedded vectors will be discarded as previously identified. This filter can eliminate unnecessary comparisons that can lead to no level of similarity, or low levels of similarity. In removing the records within the database prior to performing a similarity score calculation and/or a linear regression or other “best fit” search, the system reduces future computations. This reduced number of required comparisons represents a technical improvement, allowing computational speed for a given transaction to be improved. This reduced search space is then used further for calculating similarity scores against the query record.

### Similarity Score for Stored Records Compared to the Query Record

A similar score is generated for each stored record, where the system compares a vector representation of each stored record against a vector representation of the query record. Preferably, the similarity score for all embedded vectors remaining within the compressed search space (i.e., after filtering out one or more records) is calculated using cosine similarity.

Following is the cosine similarity formula, where ‘x’ is the query record and ‘y’ are the neighboring record vectors.

$$\begin{matrix}Cosine Similarity & \\ Similarity ( x , y ) = \frac{\vec{x} \cdot \vec{y}}{‖ \vec{x} ‖ ‖ \vec{y} ‖} = \frac{{\sum }_{1}^{n} {x}_{i} {y}_{i}}{\sqrt{{\sum }_{1}^{n} {x}_{i}^{2}} \sqrt{{\sum }_{1}^{n} {y}_{i}^{2}}} & Formula 1\end{matrix}$$

### Record Recommendations Based on the Query Record

Based on the similarity scores (determined based on cosine similarity or other similarity scoring mechanisms), the system can rank the top similar records and create a record recommendation list for the given query record. In some configurations, the user can select how many of the top records they would like to see. For example, if the user specified five records, the user could be provided with the top five records based on the similarity score (five being purely exemplary, the user can select any number of records to view, e.g. a top “K” records, K being the selected number).

### Recorded Benefits/Costs

In some configurations, the records being analyzed can contain information regarding net costs and/or rebates associated with providing a product or service. In other configurations, the records can contain information regarding computational costs associated with a previously executed service, bandwidth requirements for a given record, etc. In some configurations, the user can select one or more benefits/costs on which further rankings can occur. In such configurations, these benefits/costs associated with the records can then be used to create a second ranking of the remaining, where available records (e.g., those within the remaining within the compressed search space) are rated based on their benefits/costs. This rating can then be used as part of a best fit determination.

### Best Fit Determination

Using the first similarity score and the rating, the system can identify the best record The system can use linear regression, PCA (Principal Component Analysis), or any other “best fit” analysis to find the line that best represents the data set for the given query record. For example, using a best fit line (e.g., a line which results in the smallest cumulative value of tangent line lengths between all vector representations of the records within the compressed search space (i.e., after filtering out one or more records), where the vector representations have coordinates according to their (A) normalized similarity scores and (B) rating), the system can rank of each item by starting at the point furthest away from (0,0) and working inward. The angle of the line determines which of the two features (ratings or normalized similarity score) will be given the most importance. If desired, the user can adjust the angle of the line to provide more weight to the ratings or to the normalized similarity score. In this manner, the system can provide ranked items by searching only a portion of the total record space, where the ranking is based on a similarity of a given record to the query record, such that the necessary number of computing flops is reduced.

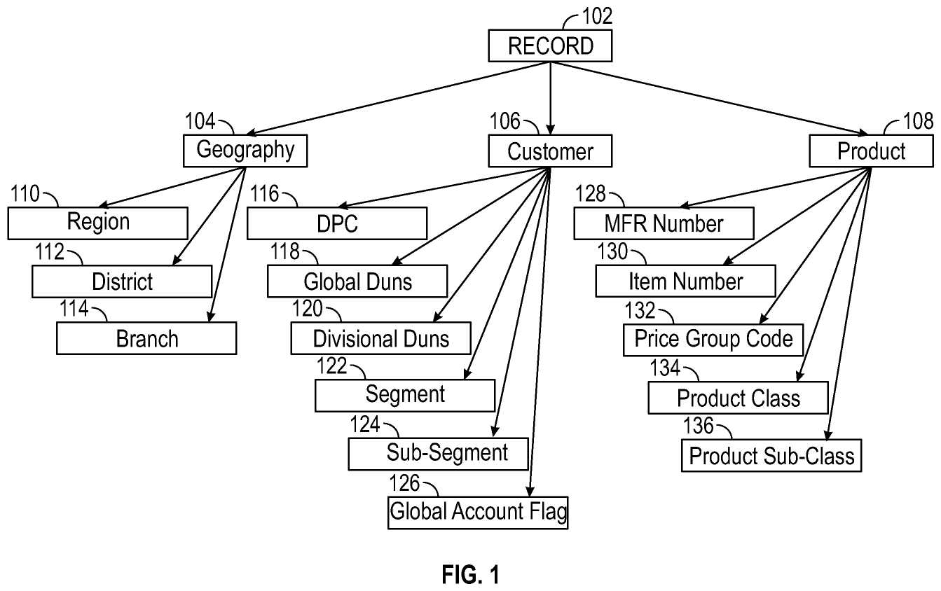

Looking at the specific examples provided by the figures, FIG. 1 illustrates an example of a hierarchical record 102, with attributes organized into classes 104, 106, 108. Attributes are specific fields within the hierarchical record 102, and may constitute strings, numbers, dates, locations, and/or any other type of data. The exemplary classes 104, 106, 108, and the categories of data associated with each of those classes 104, 106, 108 can vary from the illustrated example (e.g., contain more, less, or different classes or categories of data) as needed by a particular configuration.

A geography class 104 can have categorical data which includes: a branch identification 114 (e.g., identifying a branch where the product was manufactured, sold, etc.), a district identification 112 (e.g., a district where the product was manufactured, sold, etc.), a region identification 110 (e.g., a region where the product was manufactured, sold, etc.).

A customer class 106 can include: a DPC 116 (a distribution product company identification), Global 118 and Divisional 120 DUNS numbers (e.g., a Dun & Bradstreet D-U-N-S number identifying a business entity), business segment 122 and sub-segment 124 identifiers, and a flag 126 indicating the customer 106 has a global account.

Still another class can be associated with the product 108, and can contain categorical data such as manufacturing (MFR) number (e.g., a product number or identifier), item number 130 (e.g., a serial number), a price group code (e.g., how much the manufacturer sells the product for), and a product class 136 and subclass (e.g., a lower/first classification of the product).

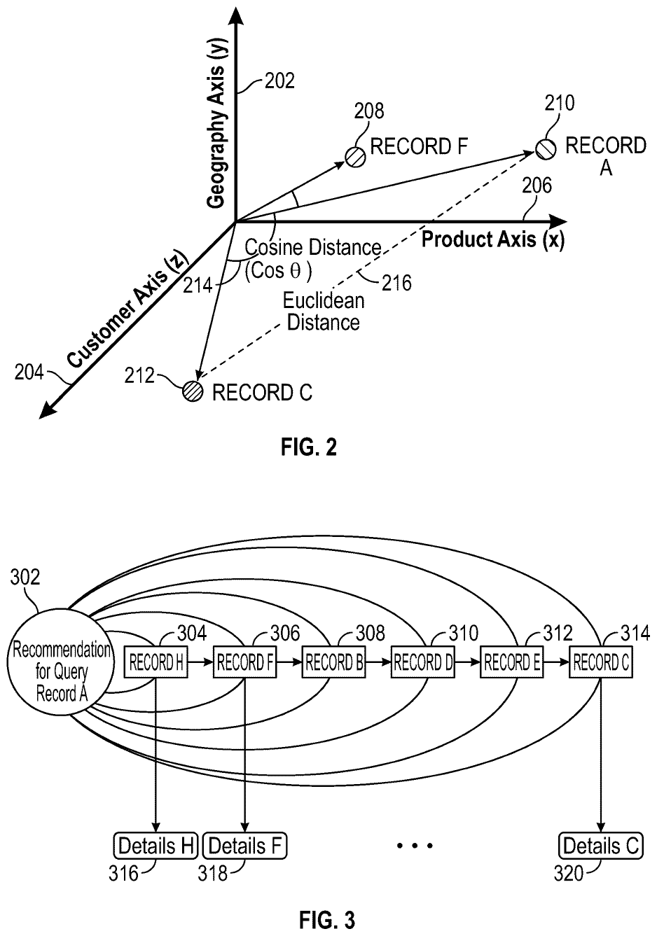

FIG. 2 illustrates an example of a multidimensional space for a record vector representation. In this example, the classes 104, 106, 108 described in FIG. 1 have been used to create vectors representing the record, with the various pieces of categorical data within each class contributing to the overall value of the vector. The vectors for each class correspond to different dimensions, such that the customer vector can be graphed along a customer axis 204, the product vector can be graphed along a product axis 206, and the geography vector can be mapped along a geography axis 202.

As illustrated, the system can graph vector representations of different records, such as records A 210, C 212, and F 208. In other configurations, actually graphing/displaying the vector representation is not required, and the data can remain in the system's memory.

The system can then measure the similarity of different records to one another using the multi-dimensional vector representations. For example, the system can measure a Euclidean distance 216 between the vector representations of records C 212 and A 210. As another example, the system can calculate the cosine distance 214 between the vector representations of records C 212 and A 210. Other mechanisms for measuring similarity between multi-dimensional vectors are likewise within the scope of this disclosure.

FIG. 3 illustrates an exemplary record search cycle. In this example, the system is looking to make recommendations for a query record A 302, and searches records H 304, F 306, B 308, D 310, E 312, and C 314. Each of the records 304-314 have details 314, 318, 320, the details including those categorical values discussed above. As illustrated in FIG. 3, based on the cosine similarity (or other similarity score), the system has determined that record H 304 is the most similar record to query record A 302, then record F 306, record B 308, record D 310, record E 312, and record C 314 (in that order). If the recommendation model is based entirely on the similarity score, record H 304 would then be provided to the user (along with any number of additional records the user may have requested).

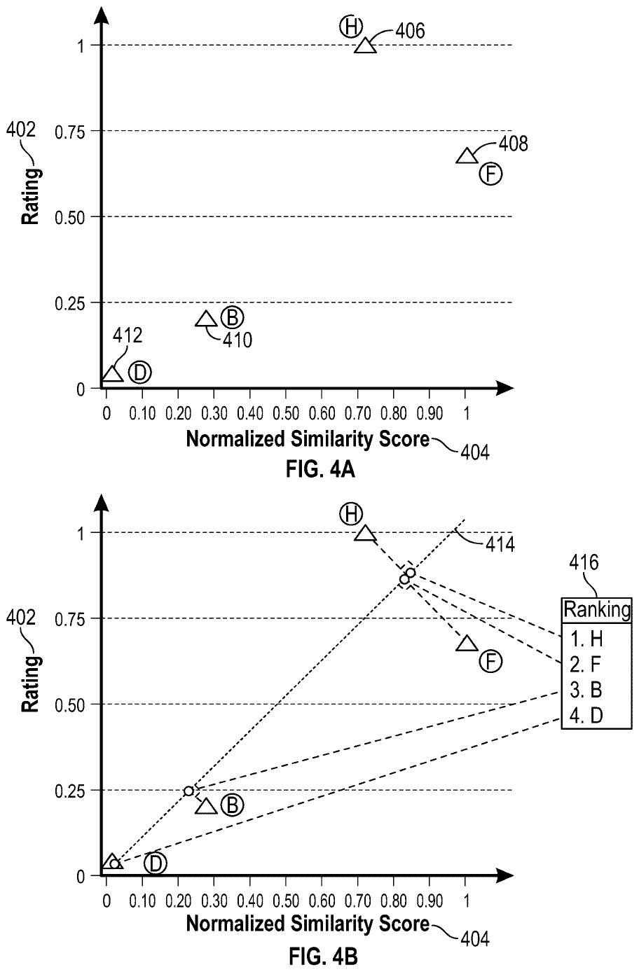

FIG. 4A illustrates an example chart of vector representations of records being graphed according to normalized similarity scores and ratings. In this example, there are four vector representations 406, 408, 410, 412 of records whose similarity scores were identified as “closest” to the query record. Their similarity scores are normalized, and the vector representations 406, 408, 410, 412 are plotted, with the normalized similarity score 404 on the x-axis, against the rating 402 (e.g., score for benefits/cost) on the y-axis. If needed, the rating 402 can also be normalized. While FIG. 4A the system can graph/chart the representations 404, 408, 410, 410 as illustrated, in other configurations the data can remain in the system memory for the following calculations.

FIG. 4B illustrates an example of using linear regression to identify a top ranking similarity score among the vector representations 404, 408, 410, 410 which were charted in FIG. 4A. Here, a best fit line 414 (e.g., a line which results in the smallest cumulative value of tangent line lengths between all vector representations of the records, where the vector representations have coordinates according to their (A) normalized similarity scores and (B) rating) is generated. Using the best fit line, the system can identify which vector representation results in a highest combination of the rating 402 and the normalized similarity score 404 (i.e., which is further to the top and right in this example), based on where the tangent line extending from the vector representation to the best fit line connects with the best fit line. As illustrated, the subsequent rankings 416 in this example are H, followed by F, B, and D (in that order). Those rankings can then be communicated to the user.

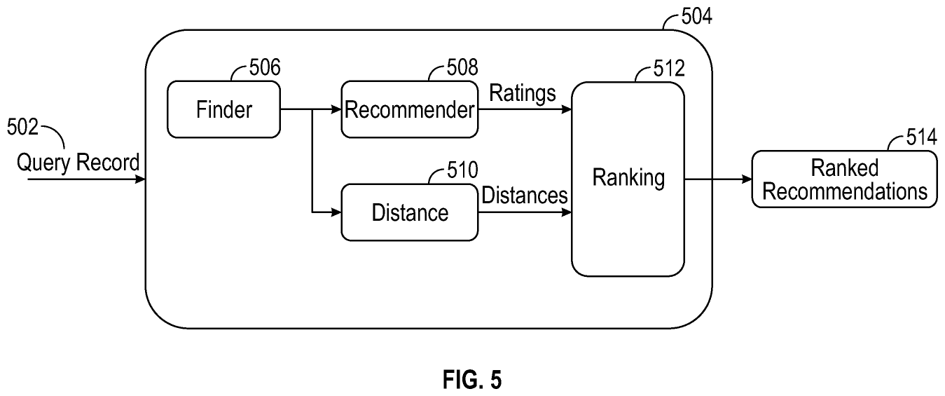

FIG. 5 illustrates an example system receiving a query and producing recommendations. As illustrated, the query is a query record 502, which the system 504 receives. The system then converts the query record 502 to a vector representation and executes a finder 506 algorithm using that vector representation. The finder 506 algorithm searches a database for similar records. Using those similar records, the system can (using a recommender 508) identify the ratings for those similar records. The system can also calculate distance 510 (using a cosine similarity, Euclidean distance, or other calculation) between the query record 502 and the identified similar records. Based on a combination of the ratings and the distances, the system 504 can rank 512 the similar records, resulting in the ranked recommendations 514. As illustrated, the determination of the ratings and the distances can, in some configurations, occur in parallel, whereas in other configurations the ratings/distances can be calculated sequentially.

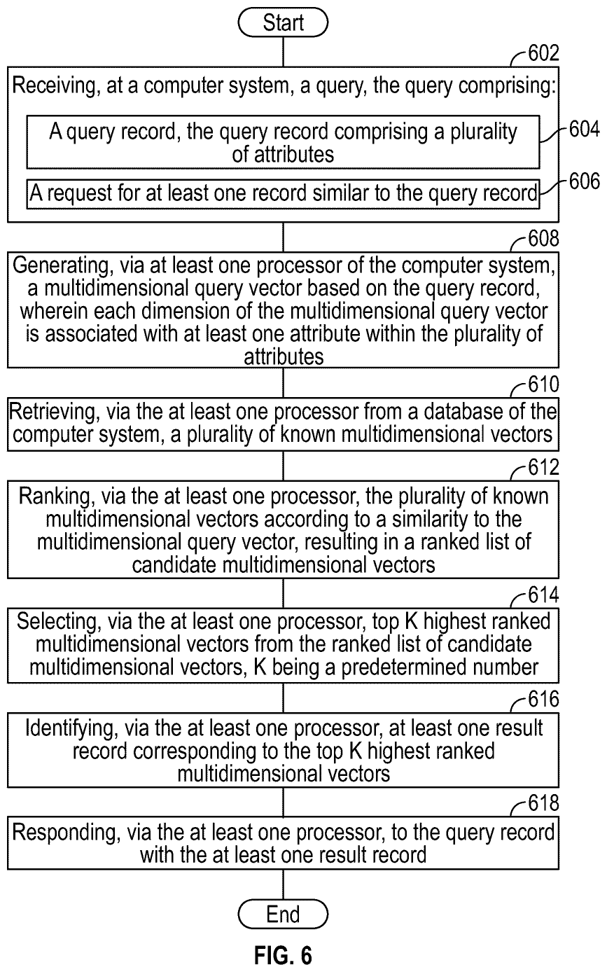

FIG. 6 illustrates an example method embodiment. The method is computer implemented and can, for example, be performed by a database management system such as the system illustrated in FIG. 5. As illustrated, the method can include receiving, at a computer system, a query (602), the query comprising: a query record, the query record comprising a plurality of attributes (604) and a request for at least one record similar to the query record (606). Preferably, the query and query record are received from a user. The step of receiving a query record comprising a plurality of attributes (604) is described above in at least paragraph [0027], and the detail therein will be understood to apply equally to the method of FIG. 6. The method can continue by generating, via at least one processor of the computer system, a multidimensional query vector based on the query record, wherein each dimension of the multidimensional query vector is associated with at least one attribute within the plurality of attributes (608). The generating of a multidimensional query vector associated with at least one attributes within the plurality of attributes (608) is described above in at least paragraph [0025], and the detail therein will be understood to apply equally to the method of FIG. 6. The method continues by retrieving, via the at least one processor from a database of the computer system, a plurality of known multidimensional vectors (610) and ranking, via the at least one processor, the plurality of known multidimensional vectors according to a similarity to the multidimensional query vector, resulting in a ranked list of candidate multidimensional vectors (612). The retrieving/searching of a plurality of known multidimensional vectors (610) is described above in at least paragraph [0027], and the detail therein will be understood to apply equally to the method of FIG. 6. Likewise, the ranking of candidate multidimensional vectors (612) is described above in at least paragraph [0032], and the detail therein will be understood to apply equally to the method of FIG. 6. The method then selects, via the at least one processor, top K highest ranked multidimensional vectors from the ranked list of candidate multidimensional vectors, K being a predetermined number (614), identifies, via the at least one processor, at least one result record corresponding to the top K highest ranked multidimensional vectors (616), and responds, via the at least one processor, to the query record with the at least one result record (618). Likewise, the selection of the top K highest ranked multidimensional vectors (614) and providing those selections as a response to the query record (618) is described above in at least paragraph [0032], and the detail therein will be understood to apply equally to the method of FIG. 6. The at least one result records can then be presented to the user as a response to the query.

In some configurations, the similarity of the plurality of known multidimensional vectors to the multidimensional query vector can be determined by: calculating, via the at least one processor, a cosine similarity between the multidimensional query vector and each multidimensional vector within the plurality of known multidimensional vectors, resulting in cosine similarity scores; and ranking the plurality of known multidimensional vectors according to the cosine similarity scores, resulting in the ranked list of candidate multidimensional vectors.

In some configurations, the similarity of the plurality of known multidimensional vectors to the multidimensional query vector can be determined by: calculating, via the at least one processor, a cosine similarity between the multidimensional query vector and each multidimensional vector within the plurality of known multidimensional vectors, resulting in cosine similarity scores; executing, via the at least one processor, a regression analysis of the plurality of known multidimensional vectors using the cosine similarity scores and at least one attribute of the plurality of attributes, resulting in regression coefficients for each of the plurality of known multidimensional vectors; ranking the plurality of known multidimensional vectors according to the regression coefficients, resulting in the ranked list of candidate multidimensional vectors. In such configurations, the calculating of the cosine similarity and the executing of the regression analysis are performed via the at least one processor using parallel processing.

In some configurations the illustrated method can further include: receiving, at the computer system, an attribute selection from within the plurality of attributes; filtering, via the at least one processor based on the attribute selection and prior to the ranking, the plurality of known multidimensional vectors such that multidimensional vectors within the plurality of known multidimensional vectors which do not have a vector corresponding to the attribute selection are removed.

In some configurations the multidimensional query vector and the plurality of known multidimensional vectors comprise at least three distinct vectors associated with at least three distinct attributes.

In some configurations the plurality of attributes can include: a unit identification; at least one unit classification; a receiving entity; and a geographic identification.

In some configurations, the plurality of attributes are hierarchical, where lower values associated with lower tier attributes are aggregated together according to weights to form higher values associated with higher tier attributes. In such configurations, there can be at least two tiers of attributes, forming higher tier attributes and lower tier attributes, there being at least three attributes in the higher tier attributes.

In some configurations, the plurality of attributes can include a query ship and debit rebate value (e.g., the value of a rebate provided by a supplier upon a sale occurring), and the plurality of known multidimensional vectors can each include at least one vector which is a ship and debit rebate value, such that the top K highest ranked multidimensional vectors are ranked based on a similarity of the query ship and debit rebate value compared to the at least one vector.

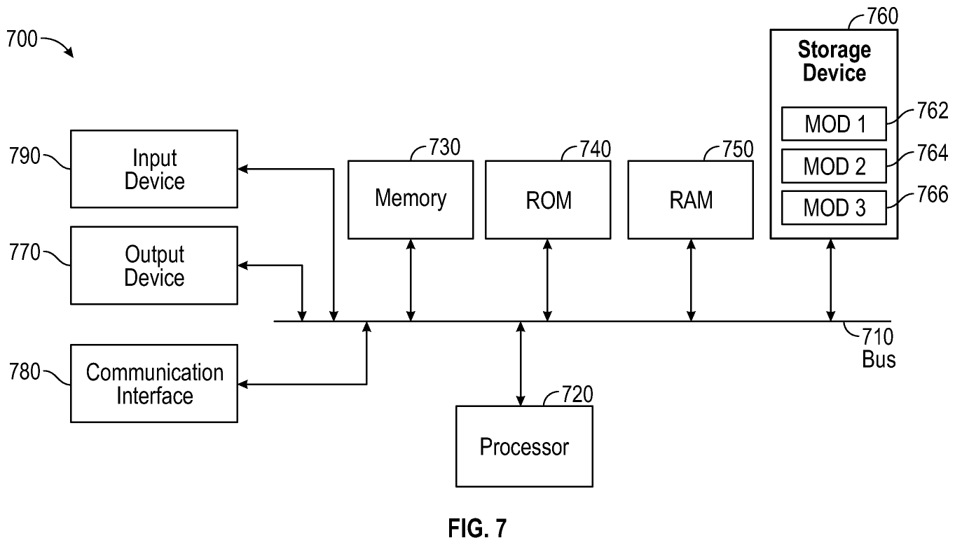

With reference to FIG. 7, an exemplary system includes a general-purpose computing device 700, including a processing unit (CPU or processor) 720 and a system bus 710 that couples various system components including the system memory 730 such as read-only memory (ROM) 740 and random-access memory (RAM) 750 to the processor 720. The system 700 can include a cache of high-speed memory connected directly with, in close proximity to, or integrated as part of the processor 720. The system 700 copies data from the memory 730 and/or the storage device 760 to the cache for quick access by the processor 720. In this way, the cache provides a performance boost that avoids processor 720 delays while waiting for data. These and other modules can control or be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general-purpose processor and a hardware module or software module, such as module 1 762, module 2 764, and module 3 766 stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer-readable storage media provide nonvolatile storage of computer-readable instructions, data structures, program modules and other data for the computing device 700. In one aspect, a hardware module that performs a particular function includes the software component stored in a tangible computer-readable storage medium in connection with the necessary hardware components, such as the processor 720, bus 710, display 770, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the device 700 is a small, handheld computing device, a desktop computer, or a computer server.

Although the exemplary embodiment described herein employs the hard disk 760, other types of computer-readable media which can store data that are accessible by a computer, such as magnetic cassettes, flash memory cards, digital versatile disks, cartridges, random access memories (RAMs) 750, and read-only memory (ROM) 740, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A computer-implemented method comprising: receiving, at a computer system, a query from a user, the query comprising: a query record, the query record comprising a plurality of attributes; and a request for at least one record similar to the query record; generating, via at least one processor of the computer system, a multidimensional query vector based on the query record, wherein each dimension of the multidimensional query vector is associated with at least one attribute within the plurality of attributes; retrieving, via the at least one processor from a database of the computer system, a plurality of known multidimensional vectors, the database comprising additional multidimensional vectors which are not retrieved; ranking, via the at least one processor, the plurality of known multidimensional vectors according to a similarity to the multidimensional query vector, resulting in a ranked list of candidate multidimensional vectors; selecting, via the at least one processor, top K highest ranked multidimensional vectors from the ranked list of candidate multidimensional vectors, K being a predetermined number; identifying, via the at least one processor, at least one result record corresponding to the top K highest ranked multidimensional vectors; and responding, via the at least one processor, to the user in response to the query with the at least one result record.

The computer-implemented method of any preceding clause, wherein the similarity of the plurality of known multidimensional vectors to the multidimensional query vector is determined by: calculating, via the at least one processor, a cosine similarity between the multidimensional query vector and each multidimensional vector within the plurality of known multidimensional vectors, resulting in cosine similarity scores; and ranking the plurality of known multidimensional vectors according to the cosine similarity scores, resulting in the ranked list of candidate multidimensional vectors.

The computer-implemented method of any preceding clause, wherein the similarity of the plurality of known multidimensional vectors to the multidimensional query vector is determined by: calculating, via the at least one processor, a cosine similarity between the multidimensional query vector and each multidimensional vector within the plurality of known multidimensional vectors, resulting in cosine similarity scores; executing, via the at least one processor, a regression analysis of the plurality of known multidimensional vectors using the cosine similarity scores and at least one attribute of the plurality of attributes, resulting in regression coefficients for each of the plurality of known multidimensional vectors; and ranking the plurality of known multidimensional vectors according to the regression coefficients, resulting in the ranked list of candidate multidimensional vectors.

The computer-implemented method of any preceding clause, wherein the calculating of the cosine similarity and the executing of the regression analysis are performed via the at least one processor using parallel processing.

The computer-implemented method of any preceding clause, further comprising: receiving, at the computer system, an attribute selection from within the plurality of attributes; filtering, via the at least one processor based on the attribute selection and prior to the ranking, the plurality of known multidimensional vectors such that multidimensional vectors within the plurality of known multidimensional vectors which do not have a vector corresponding to the attribute selection are removed.

The computer-implemented method of any preceding clause, wherein the multidimensional query vector and the plurality of known multidimensional vectors comprise at least three distinct vectors associated with at least three distinct attributes.

The computer-implemented method of any preceding clause, wherein the plurality of attributes comprise: a unit identification; at least one unit classification; a receiving entity; and a geographic identification.

The computer-implemented method of any preceding clause, wherein the plurality of attributes are hierarchical, where lower values associated with lower tier attributes are aggregated together according to weights to form higher values associated with higher tier attributes.

The computer-implemented method of any preceding clause, wherein there are two tiers of attributes, forming higher tier attributes and lower tier attributes, there being at least three attributes in the higher tier attributes.

The computer-implemented method of any preceding clause, wherein the plurality of attributes comprises a query ship and debit rebate value, and wherein the plurality of known multidimensional vectors each comprise at least one vector which is a ship and debit rebate value, such that the top K highest ranked multidimensional vectors are ranked based on a similarity of the query ship and debit rebate value compared to the at least one vector.

A system comprising: a processor; and a computer-readable storage medium storing instructions which, when executed by the processor, cause the processor to perform operations comprising: receiving, at a computer system, a query from a user, the query comprising: a query record, the query record comprising a plurality of attributes; and a request for at least one record similar to the query record; generating a multidimensional query vector based on the query record, wherein each dimension of the multidimensional query vector is associated with at least one attribute within the plurality of attributes; retrieving, from a database of the computer system, a plurality of known multidimensional vectors, the database comprising additional multidimensional vectors which are not retrieved; ranking the plurality of known multidimensional vectors according to a similarity to the multidimensional query vector, resulting in a ranked list of candidate multidimensional vectors; selecting top K highest ranked multidimensional vectors from the ranked list of candidate multidimensional vectors, K being a predetermined number; identifying at least one result record corresponding to the top K highest ranked multidimensional vectors; and responding to the user in response to the query with the at least one result record.

The system of any preceding clause, wherein the similarity of the plurality of known multidimensional vectors to the multidimensional query vector is determined by: calculating a cosine similarity between the multidimensional query vector and each multidimensional vector within the plurality of known multidimensional vectors, resulting in cosine similarity scores; and ranking the plurality of known multidimensional vectors according to the cosine similarity scores, resulting in the ranked list of candidate multidimensional vectors.

The system of any preceding clause, wherein the similarity of the plurality of known multidimensional vectors to the multidimensional query vector is determined by: calculating a cosine similarity between the multidimensional query vector and each multidimensional vector within the plurality of known multidimensional vectors, resulting in cosine similarity scores; executing a regression analysis of the plurality of known multidimensional vectors using the cosine similarity scores and at least one attribute of the plurality of attributes, resulting in regression coefficients for each of the plurality of known multidimensional vectors; and ranking the plurality of known multidimensional vectors according to the regression coefficients, resulting in the ranked list of candidate multidimensional vectors.

The system of any preceding clause, wherein the calculating of the cosine similarity and the executing of the regression analysis are performed using parallel processing.

The system of any preceding clause, the non-transitory computer-readable storage medium having additional instructions stored which, when executed by the at least one processor, cause the at least one processor to perform operations comprising: receiving, at the computer system, an attribute selection from within the plurality of attributes; filtering, based on the attribute selection and prior to the ranking, the plurality of known multidimensional vectors such that multidimensional vectors within the plurality of known multidimensional vectors which do not have a vector corresponding to the attribute selection are removed.

The system of any preceding clause, wherein the multidimensional query vector and the plurality of known multidimensional vectors comprise at least three distinct vectors associated with at least three distinct attributes.

The system of any preceding clause, wherein the plurality of attributes comprise: a unit identification; at least one unit classification; a receiving entity; and a geographic identification.

The system of any preceding clause, wherein the plurality of attributes are hierarchical, where lower values associated with lower tier attributes are aggregated together according to weights to form higher values associated with higher tier attributes.

The system of any preceding clause, wherein there are two tiers of attributes, forming higher tier attributes and lower tier attributes, there being at least three attributes in the higher tier attributes.

The system of any preceding clause, wherein the plurality of attributes comprises a query ship and debit rebate value, and wherein the plurality of known multidimensional vectors each comprise at least one vector which is a ship and debit rebate value, such that the top K highest ranked multidimensional vectors are ranked based on a similarity of the query ship and debit rebate value compared to the at least one vector.

A computer-readable storage medium storing instructions which, when executed by a computing device, cause the computing device to perform operations comprising: receiving, at a computer system, a query from a user, the query comprising: a query record, the query record comprising a plurality of attributes; and a request for at least one record similar to the query record; generating a multidimensional query vector based on the query record, wherein each dimension of the multidimensional query vector is associated with at least one attribute within the plurality of attributes; retrieving, from a database of the computer system, a plurality of known multidimensional vectors, the database comprising additional multidimensional vectors which are not retrieved; ranking the plurality of known multidimensional vectors according to a similarity to the multidimensional query vector, resulting in a ranked list of candidate multidimensional vectors; selecting top K highest ranked multidimensional vectors from the ranked list of candidate multidimensional vectors, K being a predetermined number; identifying at least one result record corresponding to the top K highest ranked multidimensional vectors; and responding to the user in response to the query with the at least one result record.

The computer-readable storage medium of any preceding clause, wherein the similarity of the plurality of known multidimensional vectors to the multidimensional query vector is determined by: calculating a cosine similarity between the multidimensional query vector and each multidimensional vector within the plurality of known multidimensional vectors, resulting in cosine similarity scores; and ranking the plurality of known multidimensional vectors according to the cosine similarity scores, resulting in the ranked list of candidate multidimensional vectors.

The computer-readable storage medium of any preceding clause, wherein the similarity of the plurality of known multidimensional vectors to the multidimensional query vector is determined by: calculating a cosine similarity between the multidimensional query vector and each multidimensional vector within the plurality of known multidimensional vectors, resulting in cosine similarity scores; executing a regression analysis of the plurality of known multidimensional vectors using the cosine similarity scores and at least one attribute of the plurality of attributes, resulting in regression coefficients for each of the plurality of known multidimensional vectors; ranking the plurality of known multidimensional vectors according to the regression coefficients, resulting in the ranked list of candidate multidimensional vectors.

The computer-readable storage medium of any preceding clause, wherein the calculating of the cosine similarity and the executing of the regression analysis are performed using parallel processing.

The computer-readable storage medium of any preceding clause, the non-transitory computer-readable storage medium having additional instructions stored which, when executed by the at least one processor, cause the at least one processor to perform operations comprising: receiving, at the computer system, an attribute selection from within the plurality of attributes; filtering, based on the attribute selection and prior to the ranking, the plurality of known multidimensional vectors such that multidimensional vectors within the plurality of known multidimensional vectors which do not have a vector corresponding to the attribute selection are removed.

The computer-readable storage medium of any preceding clause, wherein the multidimensional query vector and the plurality of known multidimensional vectors comprise at least three distinct vectors associated with at least three distinct attributes.

The computer-readable storage medium of any preceding clause, wherein the plurality of attributes comprise: a unit identification; at least one unit classification; a receiving entity; and a geographic identification.

The computer-readable storage medium of any preceding clause, wherein the plurality of attributes are hierarchical, where lower values associated with lower tier attributes are aggregated together according to weights to form higher values associated with higher tier attributes.

The computer-readable storage medium of any preceding clause, wherein there are two tiers of attributes, forming higher tier attributes and lower tier attributes, there being at least three attributes in the higher tier attributes.

The computer-readable storage medium of any preceding clause, wherein the plurality of attributes comprises a query ship and debit rebate value, and wherein the plurality of known multidimensional vectors each comprise at least one vector which is a ship and debit rebate value, such that the top K highest ranked multidimensional vectors are ranked based on a similarity of the query ship and debit rebate value compared to the at least one vector.

We claim:

1. A computer-implemented method comprising:
receiving, at a computer system, a query from a user, the query comprising:
a query record, the query record comprising a plurality of attributes; and
a request for at least one record similar to the query record;
generating, via at least one processor of the computer system, a multidimensional query vector based on the query record, wherein each dimension of the multidimensional query vector is associated with at least one attribute within the plurality of attributes;
retrieving, via the at least one processor from a database of the computer system, a plurality of known multidimensional vectors, the database comprising additional multidimensional vectors which are not retrieved;
ranking, via the at least one processor, the plurality of known multidimensional vectors according to a similarity to the multidimensional query vector, resulting in a ranked list of candidate multidimensional vectors;
selecting, via the at least one processor, top K highest ranked multidimensional vectors from the ranked list of candidate multidimensional vectors, K being a predetermined number;
identifying, via the at least one processor, at least one result record corresponding to the top K highest ranked multidimensional vectors; and
responding, via the at least one processor, to the user in response to the query with the at least one result record.

2. The computer-implemented method of claim 1, wherein the similarity of the plurality of known multidimensional vectors to the multidimensional query vector is determined by:
calculating, via the at least one processor, a cosine similarity between the multidimensional query vector and each multidimensional vector within the plurality of known multidimensional vectors, resulting in cosine similarity scores; and
ranking the plurality of known multidimensional vectors according to the cosine similarity scores, resulting in the ranked list of candidate multidimensional vectors.

3. The computer-implemented method of claim 1, wherein the similarity of the plurality of known multidimensional vectors to the multidimensional query vector is determined by:
calculating, via the at least one processor, a cosine similarity between the multidimensional query vector and each multidimensional vector within the plurality of known multidimensional vectors, resulting in cosine similarity scores;
executing, via the at least one processor, a regression analysis of the plurality of known multidimensional vectors using the cosine similarity scores and at least one attribute of the plurality of attributes, resulting in regression coefficients for each of the plurality of known multidimensional vectors; and
ranking the plurality of known multidimensional vectors according to the regression coefficients, resulting in the ranked list of candidate multidimensional vectors.

4. The computer-implemented method of claim 3, wherein the calculating of the cosine similarity and the executing of the regression analysis are performed via the at least one processor using parallel processing.

5. The computer-implemented method of claim 1, further comprising:
receiving, at the computer system, an attribute selection from within the plurality of attributes;
filtering, via the at least one processor based on the attribute selection and prior to the ranking, the plurality of known multidimensional vectors such that multidimensional vectors within the plurality of known multidimensional vectors which do not have a vector corresponding to the attribute selection are removed.

6. The computer-implemented method of claim 1, wherein the multidimensional query vector and the plurality of known multidimensional vectors comprise at least three distinct vectors associated with at least three distinct attributes.

7. The computer-implemented method of claim 1, wherein the plurality of attributes comprise:
a unit identification;
at least one unit classification;
a receiving entity; and
a geographic identification.

8. The computer-implemented method of claim 1, wherein the plurality of attributes are hierarchical, where lower values associated with lower tier attributes are aggregated together according to weights to form higher values associated with higher tier attributes.

9. The computer-implemented method of claim 8, wherein there are two tiers of attributes, forming higher tier attributes and lower tier attributes, there being at least three attributes in the higher tier attributes.

10. The computer-implemented method of claim 1, wherein the plurality of attributes comprises a query ship and debit rebate value, and wherein the plurality of known multidimensional vectors each comprise at least one vector which is a ship and debit rebate value, such that the top K highest ranked multidimensional vectors are ranked based on a similarity of the query ship and debit rebate value compared to the at least one vector.

11. A system comprising:
a processor; and
a computer-readable storage medium storing instructions which, when executed by the processor, cause the processor to perform operations comprising:
receiving, at a computer system, a query from a user, the query comprising:
a query record, the query record comprising a plurality of attributes; and
a request for at least one record similar to the query record;
generating a multidimensional query vector based on the query record, wherein each dimension of the multidimensional query vector is associated with at least one attribute within the plurality of attributes;
retrieving, from a database of the computer system, a plurality of known multidimensional vectors, the database comprising additional multidimensional vectors which are not retrieved;
ranking the plurality of known multidimensional vectors according to a similarity to the multidimensional query vector, resulting in a ranked list of candidate multidimensional vectors;
selecting top K highest ranked multidimensional vectors from the ranked list of candidate multidimensional vectors, K being a predetermined number;
identifying at least one result record corresponding to the top K highest ranked multidimensional vectors; and
responding to the user in response to the query with the at least one result record.

12. The system of claim 11, wherein the similarity of the plurality of known multidimensional vectors to the multidimensional query vector is determined by:
calculating a cosine similarity between the multidimensional query vector and each multidimensional vector within the plurality of known multidimensional vectors, resulting in cosine similarity scores; and
ranking the plurality of known multidimensional vectors according to the cosine similarity scores, resulting in the ranked list of candidate multidimensional vectors.

13. The system of claim 11, wherein the similarity of the plurality of known multidimensional vectors to the multidimensional query vector is determined by:
calculating a cosine similarity between the multidimensional query vector and each multidimensional vector within the plurality of known multidimensional vectors, resulting in cosine similarity scores;
executing a regression analysis of the plurality of known multidimensional vectors using the cosine similarity scores and at least one attribute of the plurality of attributes, resulting in regression coefficients for each of the plurality of known multidimensional vectors; and
ranking the plurality of known multidimensional vectors according to the regression coefficients, resulting in the ranked list of candidate multidimensional vectors.

14. The system of claim 13, wherein the calculating of the cosine similarity and the executing of the regression analysis are performed using parallel processing.

15. The system of claim 11, the non-transitory computer-readable storage medium having additional instructions stored which, when executed by the at least one processor, cause the at least one processor to perform operations comprising:
receiving, at the computer system, an attribute selection from within the plurality of attributes;
filtering, based on the attribute selection and prior to the ranking, the plurality of known multidimensional vectors such that multidimensional vectors within the plurality of known multidimensional vectors which do not have a vector corresponding to the attribute selection are removed.

16. The system of claim 11, wherein the multidimensional query vector and the plurality of known multidimensional vectors comprise at least three distinct vectors associated with at least three distinct attributes.

17. The system of claim 11, wherein the plurality of attributes comprise:
a unit identification;
at least one unit classification;
a receiving entity; and
a geographic identification.

18. The system of claim 11, wherein the plurality of attributes are hierarchical, where lower values associated with lower tier attributes are aggregated together according to weights to form higher values associated with higher tier attributes.

19. The system of claim 18, wherein there are two tiers of attributes, forming higher tier attributes and lower tier attributes, there being at least three attributes in the higher tier attributes.

20. A computer-readable storage medium storing instructions which, when executed by a computing device, cause the computing device to perform operations comprising:
receiving, at a computer system, a query from a user, the query comprising:
a query record, the query record comprising a plurality of attributes; and
a request for at least one record similar to the query record;
generating a multidimensional query vector based on the query record, wherein each dimension of the multidimensional query vector is associated with at least one attribute within the plurality of attributes;
retrieving, from a database of the computer system, a plurality of known multidimensional vectors, the database comprising additional multidimensional vectors which are not retrieved;
ranking the plurality of known multidimensional vectors according to a similarity to the multidimensional query vector, resulting in a ranked list of candidate multidimensional vectors;
selecting top K highest ranked multidimensional vectors from the ranked list of candidate multidimensional vectors, K being a predetermined number;
identifying at least one result record corresponding to the top K highest ranked multidimensional vectors; and
responding to the user in response to the query with the at least one result record.
